(19) United States
(12) Patent Application Publication
(10) Pub. No.: US 2003/0024369 A1
(43) Pub. Date: Feb. 6, 2003

(54) Cutting apparatus for motor vehicle tyres

(76) Inventors: Brian Peter Dunn, Harrogate (GB); Richard Brian Dunn, Harrogate (GB)

Correspondence Address: MICHAEL BEST & FRIEDRICH, LLP, 100 E WISCONSIN AVENUE, MILWAUKEE, WI, 53202, US

(21) Appl. No.: 10/169,439

(22) PCT Filed: Dec. 14, 2000
(86) PCT No.: PCT/GB00/04816

(30) Foreign Application Priority Data
Dec. 30, 1999 (GB) 9930777.9
May 12, 2000 (GB) 0011373.8

(51) Int. Cl. B26D 7/06

(52) U.S. Cl. 83/733; 83/951

(57) ABSTRACT

The invention relates to a cutting apparatus and method for breaking down of a vehicle tyre. The apparatus comprises support means for supporting a tyre in position, cutting means for cutting the tyre and rotation means for rotating the tyre during a cutting operation. The apparatus includes a track or guide (14) which is a conveying means for directing tyres toward a frame (15). The frame (15) forms part of the support means and communicates with a hopper (16) into which constituent tyre parts are deposited automatically after a cutting operation has been carried out. The cutting means comprises cutter arms (17). A support means also comprises pivot arms (18) which carry tyre guides (19) and are connected to a pivot support arm (20). Rollers (21) are provided for supporting the tyre (7) in the cutting position. The rotation means comprises a driving wheel (22).

The present invention relates to apparatus and a method for the recycling of tyres.

Vehicle tyres once they become worn beyond a certain extent, are normally replaced for reasons of safety. The worn tyre may have some remaining usable tread and may be used on another vehicle, but tyres which are too worn must be disposed of.

Vehicle tyres may also need to be replaced due to damage, and must also be disposed of.

Known methods of disposing of tyres include incineration, which provides a valuable addition to the provision of heat for generating electricity or heat for buildings when purpose made equipment is used, but which is undesirable because of the unpleasant fumes and smoke which are produced when burnt without special equipment, in the production of cement, or dumping, which is undesirable for environmental reasons since the tyres do not readily decompose naturally. Soil stabilization and the revegetation of soil are other recent uses. Tyres when fastened together may be used to provide artificial reefs in off-shore locations. Or else, recycling either to make other tyres or other products which incorporate the constituent parts of a tyre. Pyrolisis is another means of disposing of tyres where the tyres are “baked” to separate the constituent parts for recycling using specialist equipment.

Further uses such as, in the manufacture of carpet underlay, aggregate for Tarmac road surfacing, playground surfacing, a means of preventing soil compaction on sports fields, horse racing tracks, exercising areas, etc., require rubber “crumbs” which are produced by equipment with relatively delicate cutting/crumbing blades. The rubber crumb material can have about 2% steel content, and this process would benefit by using only the used tyre sections with the least amount of steel reinforcement.

Commonly, a vehicle tyre includes rubber, steel webbing reinforcement, textile webbing reinforcements, steel wire reinforcement and some petroleum products.

The strength of the tyre is determined by the use of steel and fabric webbing in the tread, steel wires in the bead of the side walls, and fabric webbing in the side walls. The side walls are therefore best suited for the manufacture of rubber crumbing and the treads suited to shredding where the steel content is acceptable.

Once the side walls are removed from the tread the main inherent strength of the tyre is considerably reduced, and the shredding of the components is relatively easy, requiring lighter equipment and giving the equipment a longer life span and less maintenance. The costs of this equipment for the shredding operation would show substantial savings compared with the equipment used for shredding whole tyres.

Companies who replace the tyres on vehicles are usually left with the worn replaced tyres. Typically, a contractor will dispose of those tyres which are unfit for reuse and will also take those tyres which still bear usable tread, either as part or in full payment for his service. Vehicle tyres because of their hollow shape and construction are relatively large in volume for relatively little mass and, accordingly, transportation costs of whole tyres can be expensive. The distance between collection from the tyre depots or fitting premises to the processing plants should be kept to a minimum to reduce costs. In addition, tyre dealers must necessarily set aside significant storage space for worn tyres whilst they await collection and they may present a fire risk.

Tyre processing units associated with local authority recycling centres located in towns and cities having adequate populations, close to the tyre depots would show a substantial saving on costs as the shredded or crumbed rubber could be transported in bulk to more distant locations for-use or further processing. Particularly as the re-treading of tyres has become less viable and the practice of tyres being collected by or for the retreading companies is declining.

Apparatus is available that removes side walls from treads and other apparatus that separates rims from the side walls but these are generally labour intensive. Tyres or sections of the tyres generally being placed onto the apparatus by hand and the separated parts placed into the appropriate container for further processing. There is also apparatus that removes steel from shredded tyres, but this is a costly operation.

Embodiments of the present invention aim to provide “production line” facilities for cutting the tyres into component parts and to segregate the cut tread from the side walls and/or beads for further processing. The treads may be shredded as a continuation of the same process or may be directed into storage bits to be further processed as a later operation if required. The side walls may also be shredded and/or crumbed as a continuation of the same process or may be directed into storage bins to be further processed as a later operation.

Accordingly, specific embodiments of the present invention aim to provide apparatus and a method for cutting the tread from the side walls and segregating the two components for further processing.

It is another aim of embodiments of the present invention to provide an apparatus and a method for cutting the tread from the side walls, the beads from the side walls, and segregating the three components for further processing.

According to one aspect of the present invention there is provided cutting apparatus for breaking down of a vehicle tyre, the apparatus comprising support means for supporting a tyre in a position in which it is to be cut, cutting means arranged in use to cut a vehicle tyre into at least two constituent parts and, rotation means for providing relative rotation of the tyre with respect to the cutting means during a cutting operation, wherein the axis of rotation is an axis of radial symmetry of the tyre, and wherein the two constituent parts comprise a tread portion of the tyre, and a side wall of the tyre.

Preferably, the cutting means is arranged in use to cut a vehicle tyre into at least three portions, wherein the portions respectively comprise a tread portion of the tyre, and two side walls of the tyre.

The cutting means may be arranged, in use, to cut the tyre so as to separate a bead portion of the tyre from a side wall of the tyre.

The cutting means may comprise a cutting tool which is movable between a first position in which it is clear of the tyre so as not to interfere with it and a second position in which it is arranged to contact with and make a first cut in the tyre.

The cutting means may further be arranged to make a second cut in the tyre.

Preferably, the first cut is arranged to separate the bead from side wall and the second cut is arranged to separate the sidewall from the tread.

The first and second cuts may be made simultaneously or sequentially.

Preferably, the cutting means is arranged to make first cuts on both sides of the tyre simultaneously.

The cutting means may comprise a pair of cutting arms each having a blade arranged on opposed inner surfaces thereof and being arranged, in use, to contact with the tyre in the area in which the respective first cuts are to be made. The cutting arms may further each comprise a second blade for contacting with an area in which a second cut is to be made.

Alternatively, the cutting arms may be movable between first and second cutting locations such that the first blades are arranged to perform the first and second cuts in a sequential manner.

The cutting arms are preferably pivotally mounted to a support frame. The cutting arms may be further connected to the rotation means for causing relative rotation, which may be mounted between said cutting arms.

The rotation means for providing relative rotation between the tyre and cutting means during cutting may be motorised, and may comprise a tread driving wheel or continuous belt for bearing against the tread of the tyre. One or more rollers are preferably provided for supporting the tyre from below during cutting. Preferably, two rollers are provided, a bottom portion of the tyre being arranged to be effectively cradled between the two rollers. Preferably, a first of the two rollers is arranged to have a fixed axis of rotation and a second of the two rollers is arranged to have its axis of rotation movable from a first position in which the tyre is cradled between the first and second rollers and a second position in which at least part of the tyre is allowed to drop into an appropriate storage means following a cutting operation. The first and second rollers may be linked together by a cantilevered cradle. The cantilevered cradle may be rotatable about the axis of rotation of the first roller.

The rotation means may be manually operatable.

The rotation means is preferably mounted to a support frame, and may be pivotally mounted to the support frame so as to be movable between an active position in which the tyre may be driven for rotation and an inactive position away from the tyre.

The apparatus is preferably arranged in use such that the tyre is rotated about a horizontally extended axis.

Alternatively the apparatus may be arranged in use such that the tyre is rotated about a vertically extended axis.

The apparatus may be arranged in use to be mounted on a vehicle.

The cutting means are preferably arranged, to perform one or more cutting operations upon the tyre from outside of a rim of the tyre.

Alternatively or additionally, the cutting means may be arranged, in use, to perform one or more cutting operations upon the tyre from inside the tyre.

The support means may further comprise means for internally supporting the tyre during a cutting operation. Preferably, said internal support means comprise guide means arranged to support the tyre internally from underneath a tread area of the tyre and are preferably arranged to support the tyre internally in an area which is substantially below the tread driving wheel. Said internal support means preferably comprise a pair of pivot arms pivotally connected to a support frame of the apparatus. Said pivot arms are preferably movable between a first position in which said guide means are not contacted with the internal tyre region and a second position in which they are. Movement from the first to second position is preferably initiated once the tyre is in the cutting position. Movement from the second to first position is preferably initiated once the tyre cutting operation is complete. Preferably, following completion of cutting, one or more constituent parts of the tyre are left hanging on the pivot arms and movement from the second to first positions is arranged to automatically deposit said one or more parts in appropriate storage means.

Alternatively, there may be a single pivot arm to support the tyre internally. In a further embodiment, one or more pivot arms may be located to support the tyre internally under the tread and further pivot arms located at the base of the tyre to give lateral support either externally or internally. This will ensure that the tyre does not move from the vertical position during the cutting process.

Appropriate storage means may comprise a hopper having a first compartment in which a tread area of the tyre is to be deposited and second and third compartments in which side wall portions of the tyre are arranged to be deposited.

According to another aspect of the present invention there is provided a method of breaking down a vehicle tyre, the method comprising cutting the tyre into at least two constituent parts, wherein the two constituent parts comprise respectively a tread portion of the tyre and a side wall of the tyre.

Preferably, the method includes cutting the tyre into at least three portions, wherein the portions comprise respectively a tread portion of the tyre and two side walls of the tyre.

The method may include cutting the tyre so as to separate a bead portion of the tyre from a side wall of the tyre.

The method may comprise causing relative movement between the tyre and one or more cutting means.

The method may include moving the cutting means between a first position in which it is arranged to cut a first region of the tyre and a second position in which it does not cut the tyre.

Preferably, the method includes moving the cutting means to a third position in which the cutting means cuts a second region of the tyre.

The method may also include supporting the tyre during its rotation. Preferably, the method includes supporting the tyre by wheels, or rollers locatable within a rim region of the tyre.

Preferably, tyres to be cut are selected and grouped according to size and conveyed by the cutting apparatus toward a cutting position. By conveying like or similar sized tyres one after another in this manner little or no size adjustment to the cutting apparatus may be required. Preferably, tyres are stacked for automatic conveying to the cutting position. Conveying may be by means of a conveyor belt for instance or by a track mechanism for rolling tyres toward the cutting position one by one.

In a further embodiment, tyres of different sizes may be stacked onto the conveyor and selected for size at the apparatus, preferably by mechanical means but may be by hand.

Preferably, adjustment means for adjusting the cutting apparatus according to tyre size is provided. Alternatively a series of apparatus set for the various sizes of tyres may be used, these may also be adjustable to cut tyres of more equal sizes.

For a better understanding of the invention, and to show how embodiments of the same may be carried into effect, reference will now be made, by way of example, to the accompanying diagrammatic drawings in which:

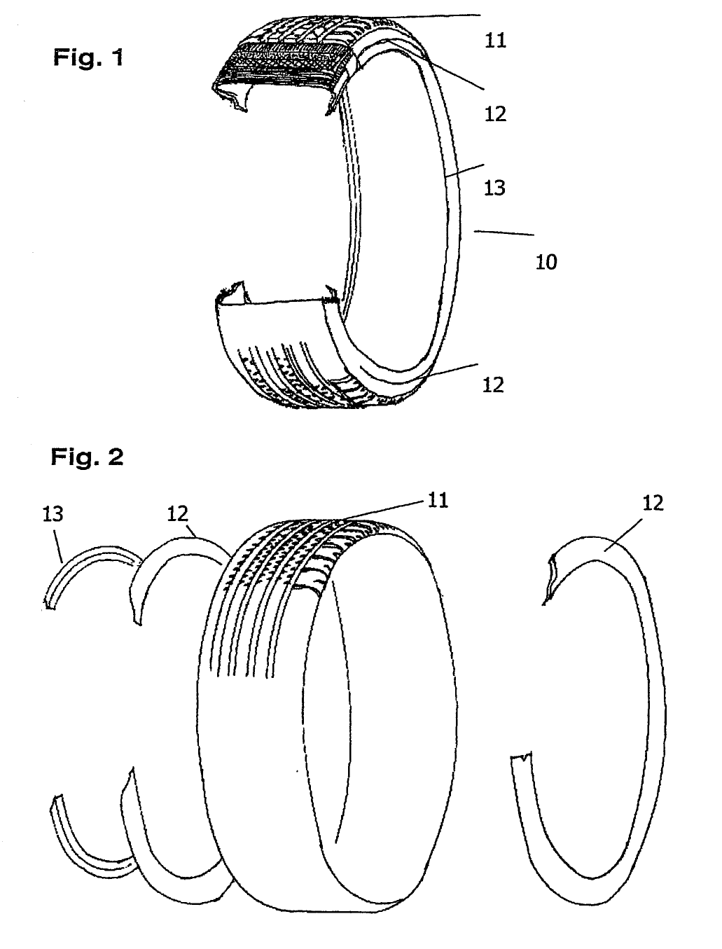

FIG. 1 shows a vehicle tyre, which is cut away to reveal its construction;

FIG. 2 shows the tyre of FIG. 1 which has been cut into various constituent parts;

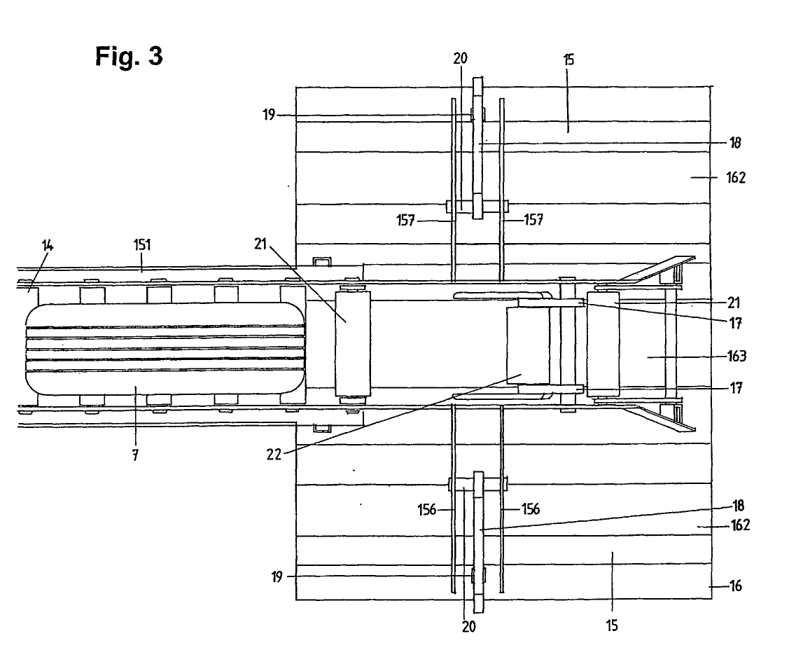

FIG. 3 is a top view of a first embodiment of the tyre cutting apparatus and showing a tyre moving towards a cutting position;

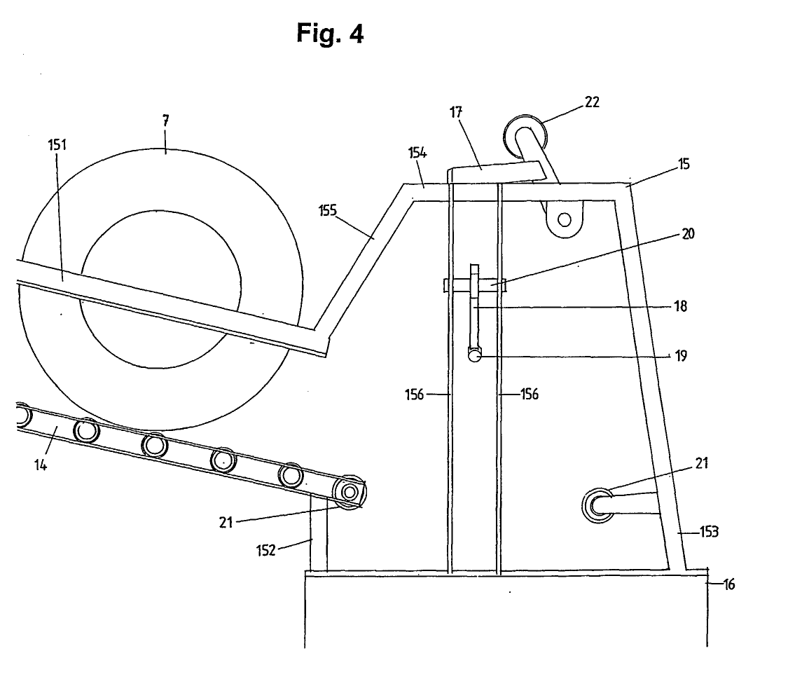

FIG. 4 is a side view of the apparatus of FIG. 3 with the tyre moving towards the cutting position;

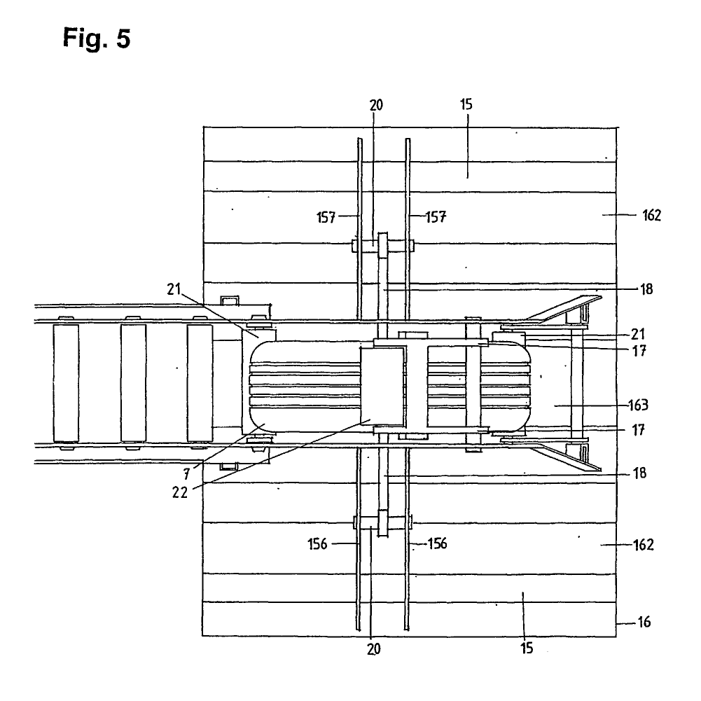

FIG. 5 is a top view of the apparatus of FIGS. 3 and 4 and showing the tyre being held in the cutting position arms;

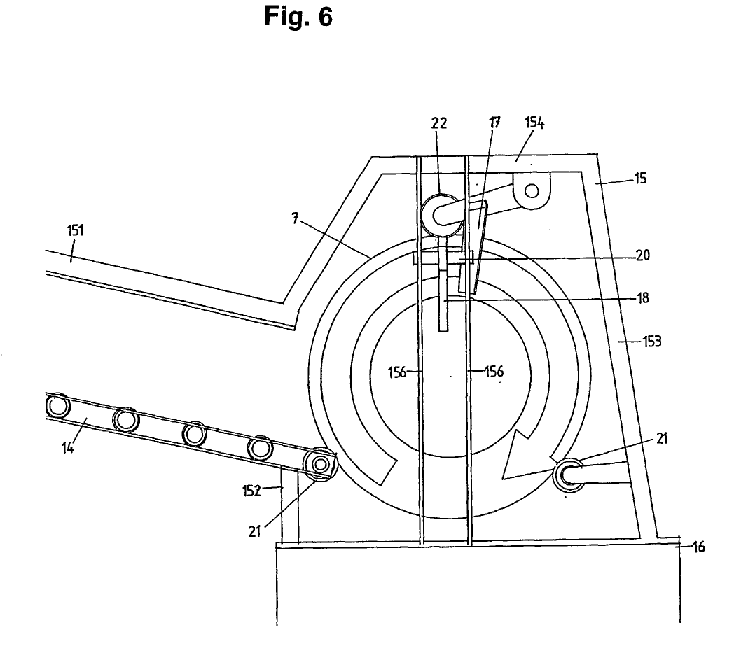

FIG. 6 is a side view of the apparatus of FIGS. 3 to 5 and showing the tyre in the same position as in FIG. 5;

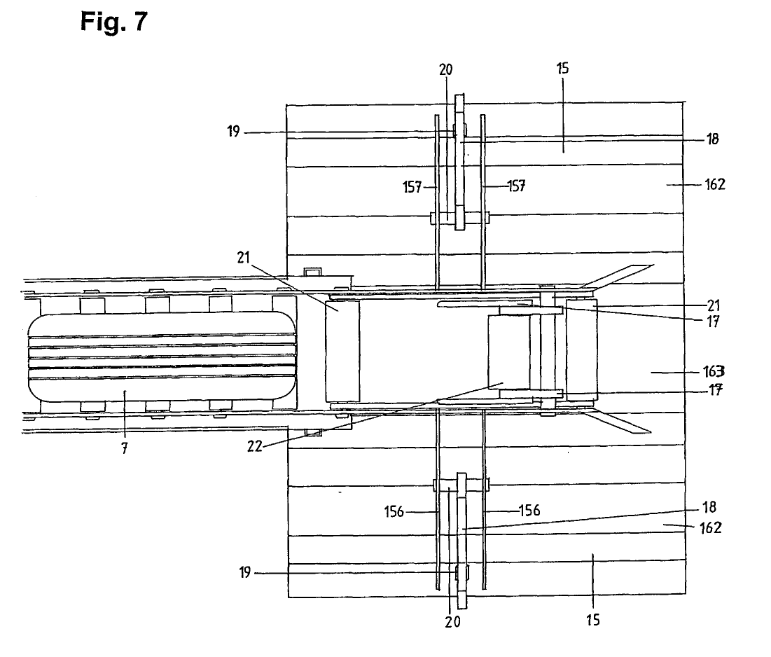

FIG. 7 is a top view of a second embodiment of the tyre cutting apparatus and showing a tyre moving towards a cutting position;

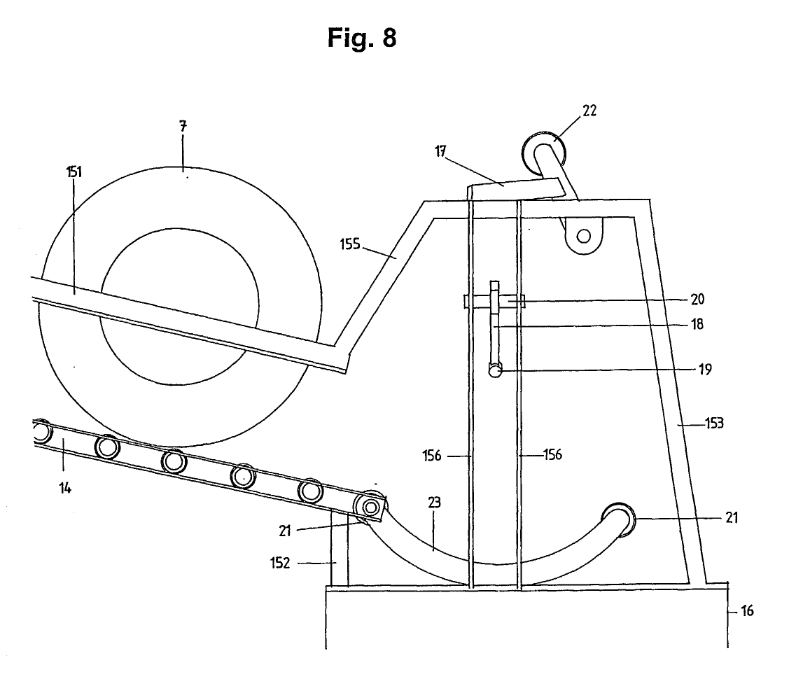

FIG. 8 is a side view of the apparatus of FIG. 7 showing the tyre moving towards the cutting position;

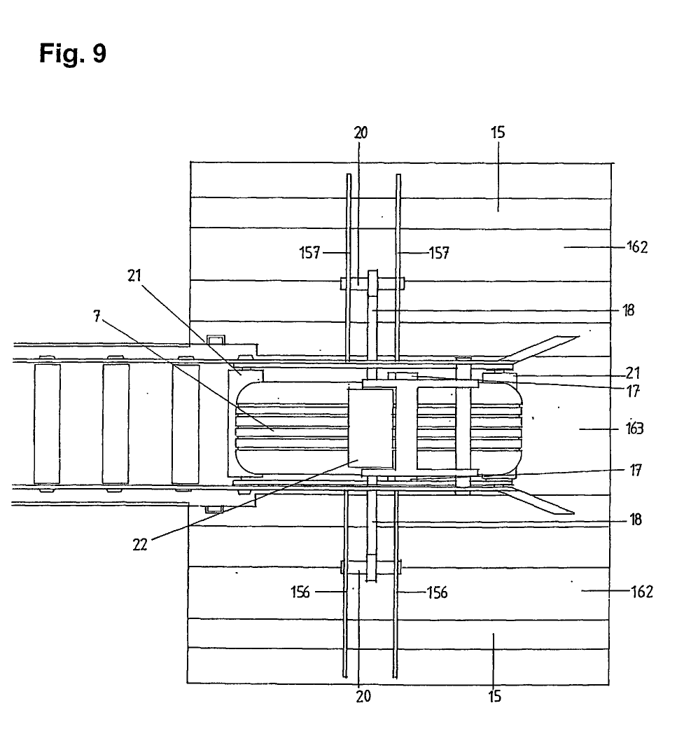

FIG. 9 is a top view of the apparatus of FIGS. 7 and 8 and showing the tyre being held in the cutting position by pivot arms;

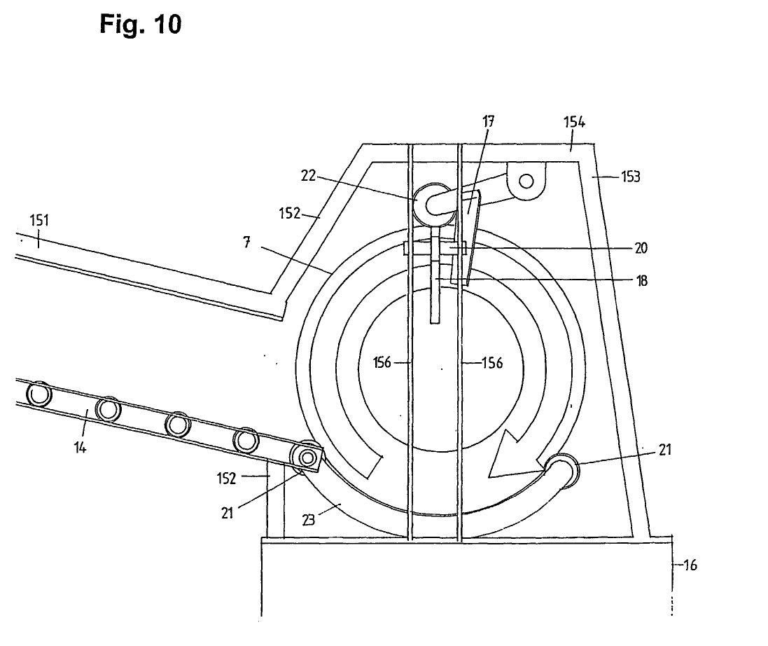

FIG. 10 is a side view of the apparatus of FIGS. 7 to 9 and showing the tyre in the cutting position;

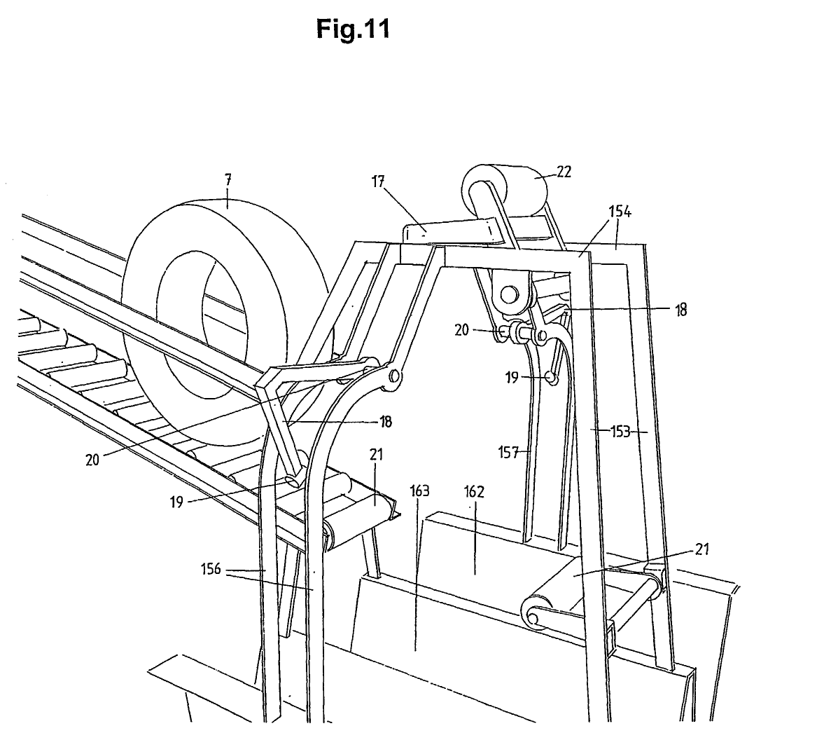

FIGS. 11 to 14 are perspective views showing the various stages in the tyre delivery and cutting operations using the apparatus of FIGS. 3 to 6; and

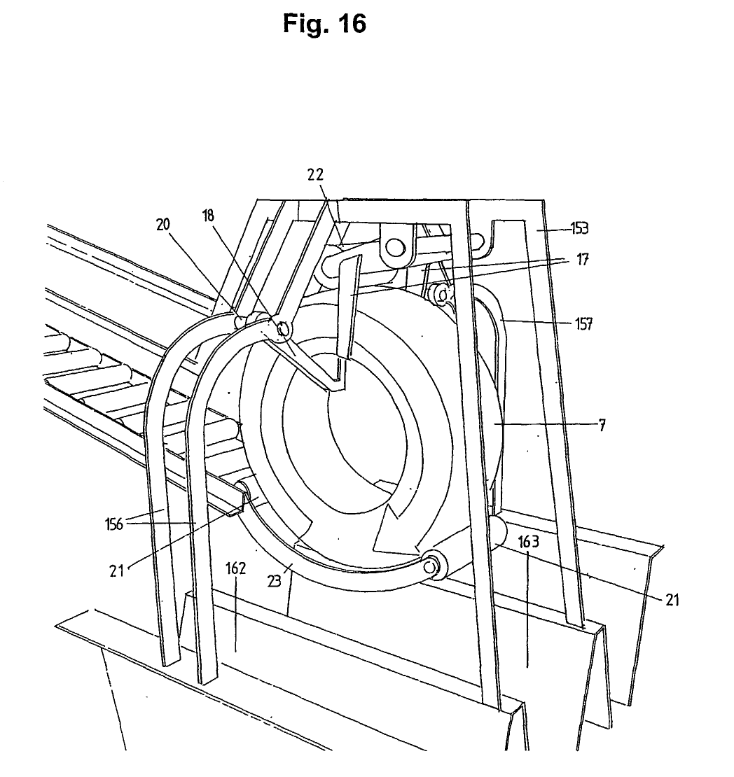

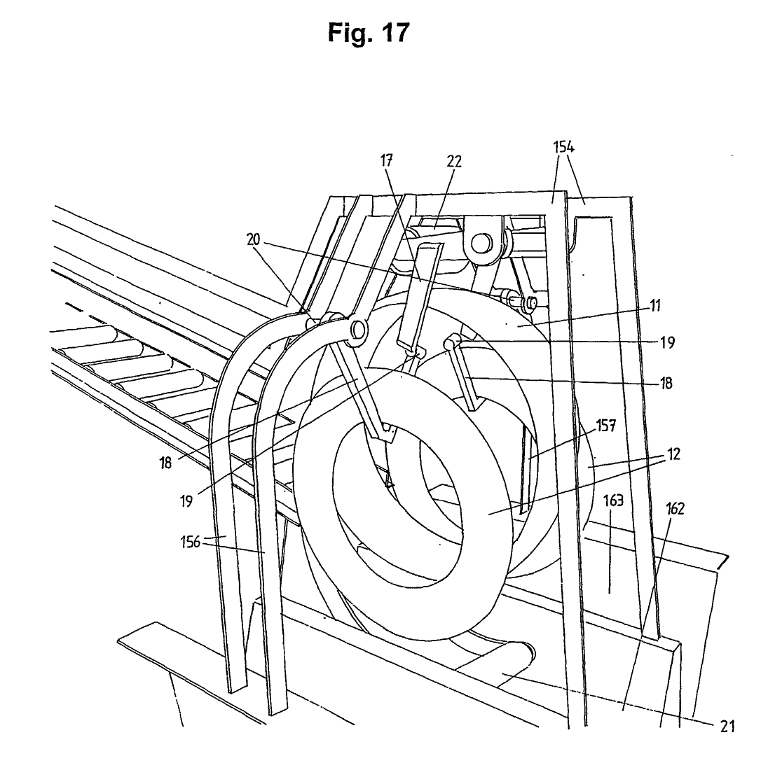

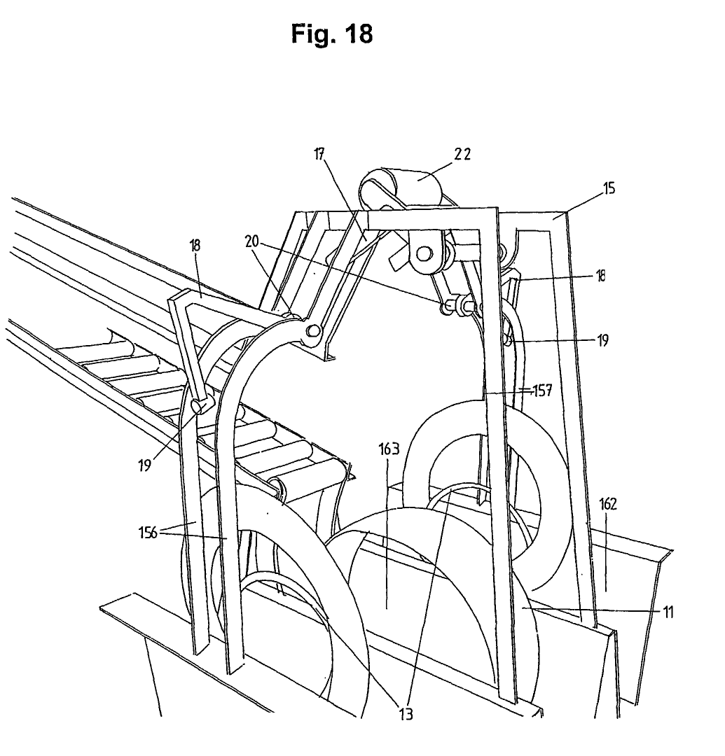

FIGS. 15 to 18 are perspective views showing the various stages in the tyre delivery and cutting operations using the apparatus of FIGS. 7 to 10.

Referring to FIG. 1 this shows a typical motor vehicle tyre 10. The tyre 10 comprises a tread portion 11, which normally contacts the road in use, and comprises a profiled rubber layer, textile webbing reinforcement (not shown) and steel webbing reinforcement, and an inner bead 13 which comprises steel wires set in rubber. The tread 11, side walls 12 and beads 13 are integrally molded in the complete tyre.

FIG. 2 shows tyre 10 with its components separated. The tread 11 is separated from the side walls 12 by making a first annular cut on each side of the tyre. The side walls 12 may be further separated from their respective beads 13 by making second cuts, if required. In this configuration the tyre 10 is more easily transported and more easily processed for recycling purposes.

Referring now to FIGS. 3 to 5, a first embodiment of the tyre cutting apparatus and method will be described. The apparatus generally comprises a support means for supporting a tyre in position, cutting means for cutting the tyre and rotation means for rotating the tyre during a cutting operation. The apparatus includes a track or guide 14 which is a conveying means for directing tyres toward a frame 15. The frame 15 forms part of the support means and communicates with a hopper 16 into which constituent tyre parts are deposited automatically after a cutting operation has been carried out. The cutting means comprises cutter arms 17. The support means also comprises pivot arms 18 which carry tyre guides 19 and are connected to a pivot arm support 20. Rollers 21 are provided for supporting the tyre 7 in the cutting position. The rotation means comprises driving wheel 22.

In more detail, the frame 15 is a support frame for helping to guide the tyre 7 into a cutting position and maintaining it there, and also for providing a mounting surface from which the cutter arms 17 and pivot arms 18 depend. Tyres are guided by means of guide rails 151 of the frame which help to channel tyres down the inclined track 14 of the conveying means and the frame 15 extends over and around the tyre periphery to provide support for the tyre 7 once it has reached a cutting position. To this end, the frame 15 further comprises upright members 152 and 153 for connecting with, respectively, an end portion of the guide track 14 and with the hopper 16, overhead in-line members 154, 155 and transverse members 156, 157 for completing the frame and supporting the various cutting and supporting elements and drive mechanisms required for rotating and cutting the tyre 7 once in the cutting position and for separating the tread from the side walls.

Considering now operation of the apparatus of FIGS. 3 to 6, and also FIGS. 11 to 13, there will now be described a cutting cycle.

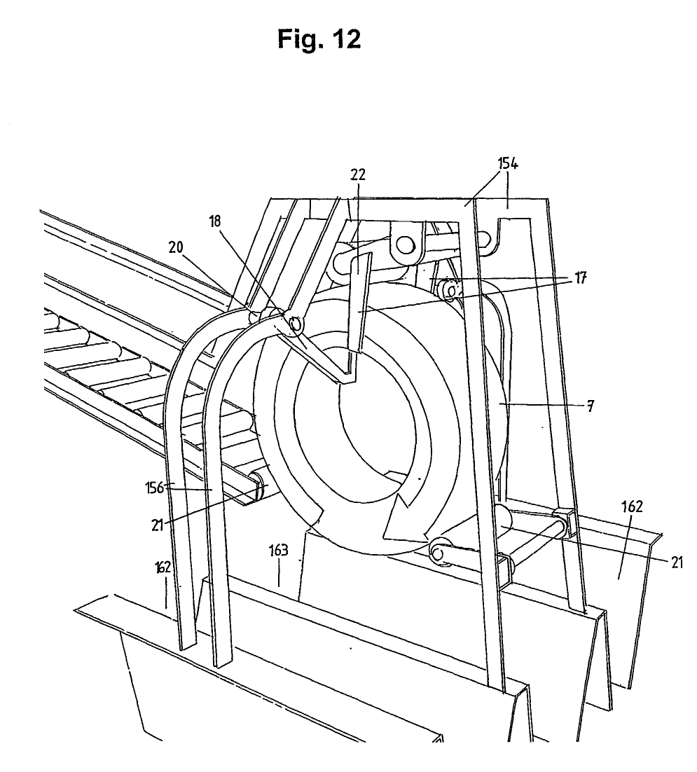

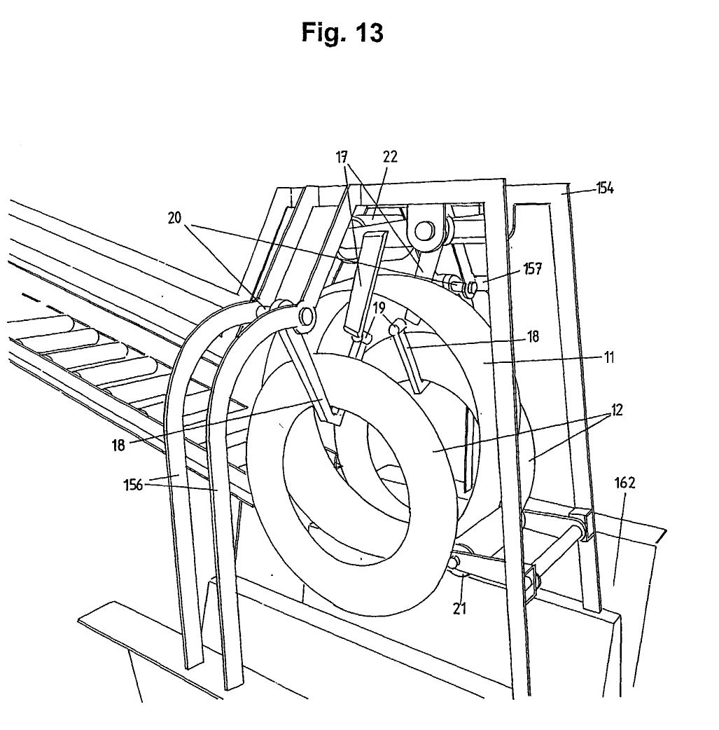

Referring initially to FIGS. 3 and 11, a tyre 7 is conveyed along track 14, constrained between side rails 151. The tyre rolls towards and into a cutting position in which it sits on rollers 21 and is supported in an upright position. Prior to the tyre 7 arriving in the cutting position, the two pivot arms 18 with their associated guides 19 are, as shown in FIG. 11 in a position in which they are effectively swung away from location in which the tyre 7 is intended to sit when supported by the rollers 21. At this time also it will be noted that the cutter arms 17 and drive wheel 19 (pivotally connected to the overhead in-line members 154, 155) are also pivoted away from the location in which the tyre will eventually sit, so as to ease entry of the tyre into its cutting position. Once the tyre 7 has entered the cutting position and is effectively cradled by the rollers 21 then the pivot arms 18 and guides 19 swing inwardly about the pivot supports 20 (which are connected to the transverse members 156, 157) so that the tyre guides 19 move inside the rim of the tyre from either side of the frame and support the tyre internally by bearing up upon the inner surface of the tyre underneath the tread area. Once the tyre is supported in this way, then the cutting blades mounted on inner faces of the cutter arms 17 are swung down from the overhead portion 154 of the frame 15 so as to make an initial cut on either side of the tyre to puncture the side walls. Driving wheel 22 comes into contact then with the tread position of the tyre and is then driven by a motor (not shown), with the underside of the tread being supported internally by the guides 19. As the driving wheel 22 rotates, the tyre 7 is rotated as illustrated by the arrow shown in FIGS. 6 and 12. It will be appreciated that the cutters on cutter arms 10 will, as the tyre is driven around, eventually, cut off the whole of each side wall. As seen from FIG. 13, the cut side walls fall onto the pivot arms 18 once the cutting cycle is complete and the roller or rollers 21 retract to allow the tread to fall into the hopper 16. As can best be seen from FIGS. 12 and 13, the hopper 16 is compartmentalised with special side wall receiving compartments 161, 162 and a tread receiving compartment 163 intermediate the side wall compartments.

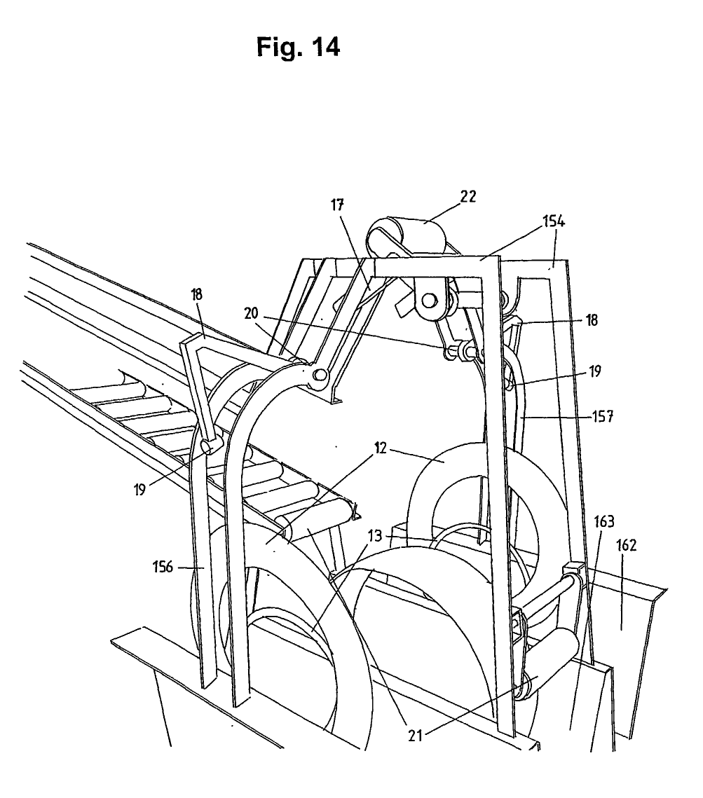

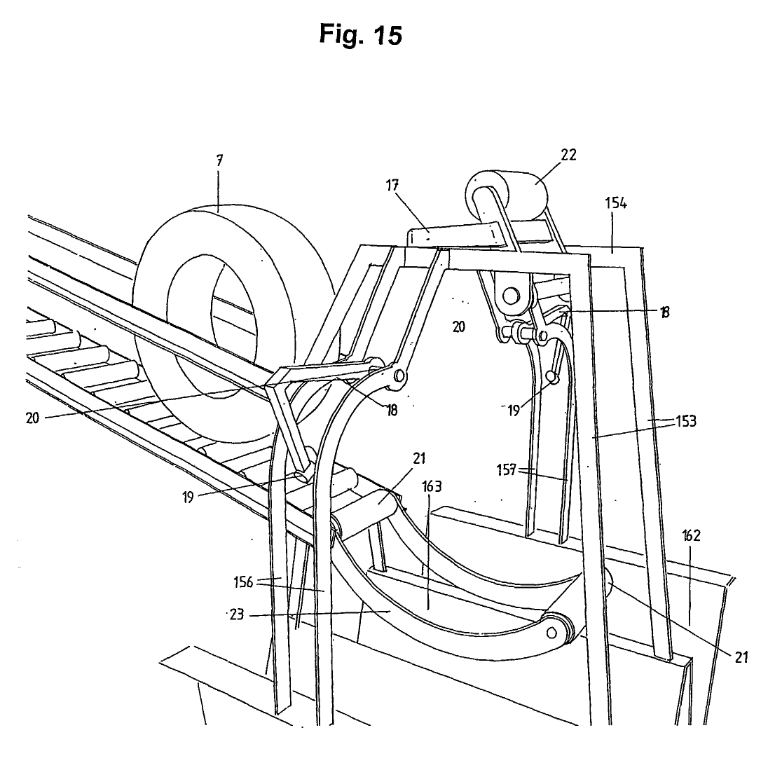

From FIG. 14 it can be seen that as the pivot arms 18 swing away from the cutting position, the side walls fall off the pivot arms and into the compartments 161, 162.

Referring now to FIGS. 7 to 10 and 15 onwards, a second embodiment of the present invention will now be described in which like elements to those shown in FIGS. 3 to 6 and 11 to 14 are given like numerals.

For ease of explanation, it is sufficient to note that the difference in the apparatus of the second embodiment from that of the apparatus of the first embodiment is that there is provided a cradle shaped element 23 linking the rollers 21 together. This cradle may be supported itself by, for instance, motor means, so that during delivery of a tyre to the cutting position and whilst the tyre is being cut, it is maintained in the position shown in FIGS. 8, 10, 15 and 16, and, once the cutting operation has taken place, the cradle is adapted to pivot downwardly about an axis running through the left hand roller 21′ so that the cradle arm 23 swings downward about said axis, to allow the tread portion of the tyre to fall into its relevant compartment 163 in the hopper 16.

It will be appreciated that movement of the pivot arms and cutter arms is preferably done automatically dependent on whether there is a tyre in the cutting position and on whether a cutting operation has been completed. In other words, prior to a tyre arriving in the cutting position, the pivot arms and cutter arms are located so as not to interfere with arrival of the tyre in the cutting position. Preferably, there is a sensor (not shown) for sensing when the tyre has arrived in the cutting position and for initiating movement of the pivot arms and cutter arms toward the tyre so as to enable a cutting operation to be carried out. Movement of the pivot arms and cutter arms may be achieved by motor means (not shown in any of the Figures so as to aid clarity).

Once the pivot arms and cutter arms have been moved into position, drive is applied to the tyre so as to rotate it and automatically cause a cutting operation to be carried out. During the cutting operation, both first types of cuts and second types of cuts may be made simultaneously. For instance, the cutting arms may have first and second cutting blades which are spaced apart from one another, so as to automatically separate the tyre into tread portions, bead portions and side walls. Also, the cutter arms may include biasing means so as to bias the two cutter arms toward one another once they are adjacent the tyre side wall so as to cause the cutter blades to pierce the tyre in the relevant places.

When the-cutter arms are in a configuration in which they are ready to start the cutting operation, drive to the drive wheel is initiated. There may also be provided a sensor for sensing when the cutting operation has been successfully completed and for automatically retracting the pivot arms and cutter arms.

Guides may be provided at the base of the vertically held tyres to keep them fully vertical during the cutting process. This may be achieved by means of fixed or moveable guides, which detect the width of the tyres.

Alternatively, there may be a single pivot arm to support under the tread, in place of the two pivot arms previously described, and a further pivot arm located diagonally opposite at the base of the tyre which would guide the tyre whilst being rotated and collect the sidewalls and rim when they had been separated.

A continuous belt may be used to rotate the tyres in place of the driving wheel.

As described previously, two blades on each cutting arm may be used to perform the cutting operations, alternatively, one blade on each arm could be used, firstly cutting off the rims then spiralling up the sidewalls until they have been separated. Or, after the rims have been separated, the blades retract until the position of the tread/sidewalls has been detected and then pierce the sidewalls for the final cuts.

Adjustment of the apparatus for different sizes of tyres may be made by the rollers being spring-mounted in FIG. 6 and by the position of the pivoted cradle in FIG. 10. As the cutting blades are retractable, they would automatically adjust to the width of the different tyres.

It will also be appreciated that other embodiments of the invention may be envisaged. For instance, in place of the cutter arms as shown in the drawings (which when they descend contact with the tyre on opposed external faces of the side walls) cutting blades may be provided which as they descend pierce through an interface between tread and side wall so as to make the first cut automatically prior to commencing rotation of the tyre. Other arrangements which may be envisaged in which blades are used to separate tread from side walls etc., by inserting blades from inside the rim of the tyre (in other words, to cut from inside out rather than from the outside in). It will also be appreciated that whilst motor drive is preferred for carrying out automated cutting up of the tyres, manual drive is also an option, in which an operator manually shifts pivot arms, cutter arms, etc., and may alternatively/additionally provide for manual rotation of the tyre during the cutting operation.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extend to any novel one, or any novel combination, of the features disclosed in this specification (including any accompanying claims, abstract and drawings), or to any novel one, or any novel combination, of the steps of any method or process so disclosed.

1. Cutting apparatus for breaking down of a vehicle tyre, the apparatus comprising support means (15, 20, 21) for supporting a tyre in a position in which it is to be cut, cutting means (17) arranged in use to cut a vehicle tyre (7) into at least two constituent parts and, rotation means (22) for providing relative rotation of the tyre (7) with respect to the cutting means (17) during a cutting operation, wherein the axis of rotation is an axis of radial symmetry of the tyre, and wherein the two constituent parts comprise a tread portion of the tyre, and a side wall of the tyre.

2. Apparatus according to claim 1, wherein the cutting means (17) is arranged in use to cut a vehicle tyre into at least three portions, wherein the portions respectively comprise a tread portion of the tyre, and two side walls of the tyre.

3. Apparatus according to claim 1 or 2, wherein the cutting means (17) is arranged, in use, to cut the tyre so as to separate a bead portion of the tyre from a side wall of the tyre.

4. Apparatus according to claim 1, 2 or 3, wherein the cutting means (17) comprises a cutting tool which is movable between a first position in which it is clear of the tyre so as not to interfere with it and a second position in which it is arranged to contact with and make a first cut in the tyre.

5. Apparatus according to claim 4, wherein the cutting means (17) is arranged to make a second cut in the tyre.

6. Apparatus according to claims 5, wherein the first cut is arranged to separate a bead area from the side wall and the second cut is arranged to separate the sidewall from the tread.

7. Apparatus according to any of the preceding claims, wherein the cutting means (17) comprises a pair of cutting arms each having a blade arranged on opposed inner surfaces thereof and being arranged, in use, to contact with the tyre (7) in the area in which the respective first cuts are to be made.

8. Apparatus according to claim 7, wherein the cutting arms (17) further each comprise a second blade for contacting with an area in which a second cut is to be made.

9. Apparatus according to claim 7 or 8, wherein the cutting arms (17) are pivotally mounted to a support frame (15).

10. Apparatus according to claim 9, wherein the cutting arms (17) are further connected to the rotation means (22) for causing relative rotation, which is mounted between said cutting arms (17).

11. Apparatus according to any of the preceding claims, wherein the rotation means (22) for providing relative rotation between the tyre (7) and cutting means (17) during cutting is motorised, and comprises a tread driving wheel or continuous belt for bearing against the tread of the tyre.

12. Apparatus according to any claim, wherein one or more rollers (21) are provided for supporting the tyre (7) from below during cutting.

13. Apparatus according to claim 12, wherein two or more rollers (21) are provided, a bottom portion of the tyre (7) being arranged to be effectively cradled between the two rollers.

14. Apparatus according to claim 13, wherein a first of the two rollers (21′) is arranged to have a fixed axis of rotation and a second of the two rollers (21′) is arranged to have its axis of rotation movable from a first position in which the tyre (7) is cradled between the first and second rollers (21′) and a second position in which at least part of the tyre is allowed to drop into an appropriate storage means following a cutting operation.

15. Apparatus according to claim 14, wherein the first and second rollers (21′) are linked together by a cantilevered cradle (23).

16. Apparatus according to claim 15, wherein the cantilevered cradle (23) is rotatable about the axis of rotation of the first roller.

17. Apparatus according to any of the preceding claims, wherein the rotation means (22) is pivotally mounted to a support frame (15), so as to be movable between an active position in which the tyre (7) may be driven for rotation and an inactive position away from the tyre.

18. Apparatus according to any of the preceding claims, wherein the support means comprises means (20) for internally supporting the tyre (7) during a cutting operation.

19. Apparatus according to claim 18, wherein said internal support means comprise guide means (20) arranged to support the tyre internally from underneath a tread area of the tyre (7).

20. Apparatus according to claim 19, wherein the tyre (7) is supported internally in an area which is substantially below an externally located tread driving wheel (22).

21. Apparatus according to claim 19 or 20, wherein said internal support means comprises a pair of pivot arms (20) pivotally connected to a support frame (15) of the apparatus.

22. Apparatus according to claim 21, wherein said pivot arms (20) are movable between a first position in which said guide means are not contacted with the internal tyre region and a second position in which they are.

23. Apparatus according to claim 22, wherein movement from the first to second position is initiated once the tyre (7) is in the cutting position.

24. Apparatus according to claim 23, wherein movement from the second to first position is initiated once the tyre (7) cutting operation is complete.

25. Apparatus according to claim 24, wherein following completion of cutting, one or more constituent parts of the tyre are left hanging on the pivot arms and movement from the second to first positions is arranged to automatically deposit said one or more parts in appropriate storage means (16).

26. Apparatus according to any preceding claims, further comprising appropriate storage means (16) into which constituent parts of the tyre are deposited after cutting.

27. Apparatus according to claim 15, 25 or 26, wherein the storage means (16) comprises a hopper having a first compartment (163) in which a tread area of the tyre is to be deposited and second and third compartments (161, 162) in which side wall portions of the tyre are arranged to be deposited.

28. Apparatus according to claim 15, 25, 26 or 27, wherein the storage means comprises storage for tyre beads.

29. Apparatus according to any of the preceding claims, wherein there is provided a guide (14) for conveying tyres toward the cutting position.
